(19) United States
(12) Patent Application Publication
(10) Pub. No.: US 2011/0232689 A1
(43) Pub. Date: Sep. 29, 2011

(54) METHOD FOR CLEANING A VACUUM PUMP

(75) Inventors: Ingo Kannen, Koeln (DE); Hagen Goettlich, Pfaefers (CH); Stefan Schneider, Valens (CH)

(73) Assignees: OERLIKON LEYBOLD VACUUM GMBH, KOELN (DE); OERLIKON SOLAR AG, TRUEBBACH, TRUEBBACH (CH)

(21) Appl. No.: 13/126,265

(22) PCT Filed: Oct. 27, 2009
(86) PCT No.: PCT/EP09/64122

§ 371 Date: Jun. 10, 2011

(30) Foreign Application Priority Data
Oct. 28, 2008 (DE) 10 2008 053 522.2

(51) Int. Cl. B08B 9/00

(52) U.S. Cl. 134/22.1

(57) ABSTRACT

A method for cleaning a vacuum pump (10) having a pump chamber (12) with at least one pump rotor (14) includes performing the steps of:

a) filling a cleaning liquid (28) into the pump chamber (12),

b) distributing the cleaning liquid (28) in the pump chamber (12),

c) dissolving impurities with the cleaning liquid (28),

d) draining the cleaning liquid (28) from the pump chamber (12).

The invention refers to a method for cleaning a vacuum pump comprising a pump chamber with at least one pump rotor.

In various applications of such vacuum pumps there is a problem of impurities being formed during operation and accumulating in the suction chamber (pump chamber). Such applications are, for example, MOCVD processes, LPCVD processes, PECvVD processes, PVD processes or the lamination of photovoltaic modules, for instance. These are processes in which process gases are used or in which reaction products are formed in the process chamber that decompose in the vacuum pump due to the pressure/temperature conditions or react with each other. As a result, particles are formed that grow in layers or exist as dust.

Such an application of a vacuum pump is, for instance, the deposition of transparent conductive oxide layers (TCO layers) for the manufacturing of solar cells, using vacuum pumps. TCO layers are made, for instance, from a combination of water and diethyl zinc. Water and diethyl zinc may react rather violently at atmospheric pressure. At low pressures of a few millibars the reaction is significantly slower. For the forming of TCO layers, both materials are therefore caused to react in a vacuum in process chambers, so as to force a slow reaction. A by-product of a reaction between water and diethyl zinc are impurities in the form of dust particles that cause accumulations in the pump housing and on the rotor. These reactions may also occur in the pump. Such accumulations reduce the maximum operating time of a pump. Cleaning a vacuum pump is troublesome and time-consuming and usually requires a dismantling of the pump in its entirety.

From DE 10 2004 063 058 A1 a rinsing method for cleaning a vacuum screw pump is known, wherein the pump is rinsed with a cleaning fluid while running at a rated speed of rotation, the cleaning fluid being a mixture of a rinsing fluid and a rinsing gas.

It is an object of the invention to provide a simple method for cleaning a vacuum pump without the pump having to be dismantled or dismounted from the installation.

The method according to the invention is defined by the features in claim 1.

The pump chamber is filled with a cleaning fluid, e.g. in the form of an acid, a base, a solvent or a softener. Moving the rotor will distribute the cleaning solution in the pumping chamber so that the cleaning solution also reaches portions in the pump chamber that are difficult to access. By moving the rotor, a mixture of the cleaning liquid and dissolved impurities is formed. This mixture is subsequently drained from the pump chamber. Dissolving the impurities by means of the cleaning liquid represents a simple cleaning method with which the maximum operating time of the vacuum pump can be increased. A clogging of the pump with accumulations of impurities, and thus a possible damage or even a destruction of the pump, can be avoided if this cleaning method is used. The cleaning method is more efficient than conventional simple rinsing methods. The duration of the cleaning process is reduced compared to conventional methods, whereby the available useful time of the pump is increased.

Compared to the known rinsing method using a rinsing fluid while the pump is operated at a rated speed of rotation, it is an advantage that impurities can be dissolved better by filling a cleaning liquid into the pump chamber and by distributing the cleaning liquid in the pump chamber independent of the rinsing process itself. This is true in particular if the cleaning process is not performed while the pump is running at a rated speed of rotation. To this end, the pump chamber inlet and the pump chamber outlet have to be closed and the pump chamber has to be flooded completely with the cleaning liquid. After the cleaning process, the vacuum pump can be rinsed using the known rinsing method, for instance.

Subsequent to the draining of the cleaning liquid, the pump chamber is rinsed with a rinsing liquid, e.g. water, and then dried before the pump is restarted. The cleaning liquid may be an acidic cleaning solution. This acidic cleaning solution dissolves deposits containing zinc.

For the purpose of increasing the efficiency of the cleaning method, the pump chamber is advantageously refilled with cleaning liquid and the liquid is distributed in the pump chamber by the rotor's movement, so that fresh cleaning liquid will reach the still remaining deposits to dissolve the same. Since the dissolved deposits use up the cleaning liquid, a repeated refilling and moving of the rotor may be necessary to enhance efficiency.

Prior to filling the cleaning liquid into the pump chamber, the pump operation should be stopped. The pump chamber inlet and the pump chamber outlet are then closed. It is particularly advantageous to let possible secondary gases escape from the pump chamber during the cleaning process. A secondary gas is nitrogen, for instance, which is used as a sealing gas (“seal shaft purge”) between the pump chamber and the adjoining transmission casing of the pump rotor or as a gas ballast intended to prevent the condensation of the compressed gas. For example, the gas ballast supply is stopped and the sealing gas flow is reduced. For ventilation purposes, a degassing opening can be made in the upper portion of the pump chamber through which the secondary gas can escape upward from the pump chamber to atmosphere. Secondary gases may prevent a uniform distribution of the cleaning liquid and thereby impair the efficiency of the cleaning process. The degassing opening may be provided with a removable stopper. For the escape of the secondary gases, a degassing pipeline may be set on the degasssing opening, through which the escaping secondary gas is guided to atmosphere. Preferably, the degassing pipeline is connected with an exhaust gas line for the pump chamber outlet.

If an acidic cleaning solution is used, the acidity in the cleaning solution should be sufficiently high for an efficient cleaning and, in that respect, sufficiently low so as to avoid any unnecessary attack on the pump components. These properties are given at acidities between 2% and 15%. A particularly advantageous acidity is about 10%. An advantageous acid for use in the cleaning liquid is citric acid.

The following is a detailed description of an embodiment of the invention with reference to the drawings.

In the Figures:

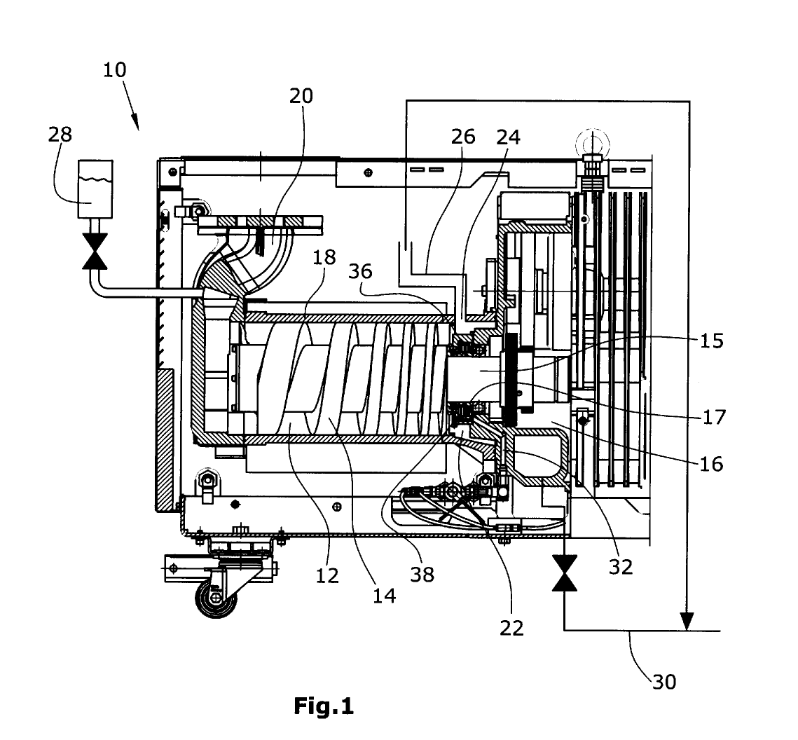

FIG. 1 is a section through a vacuum pump with a pump chamber and a pump rotor, and

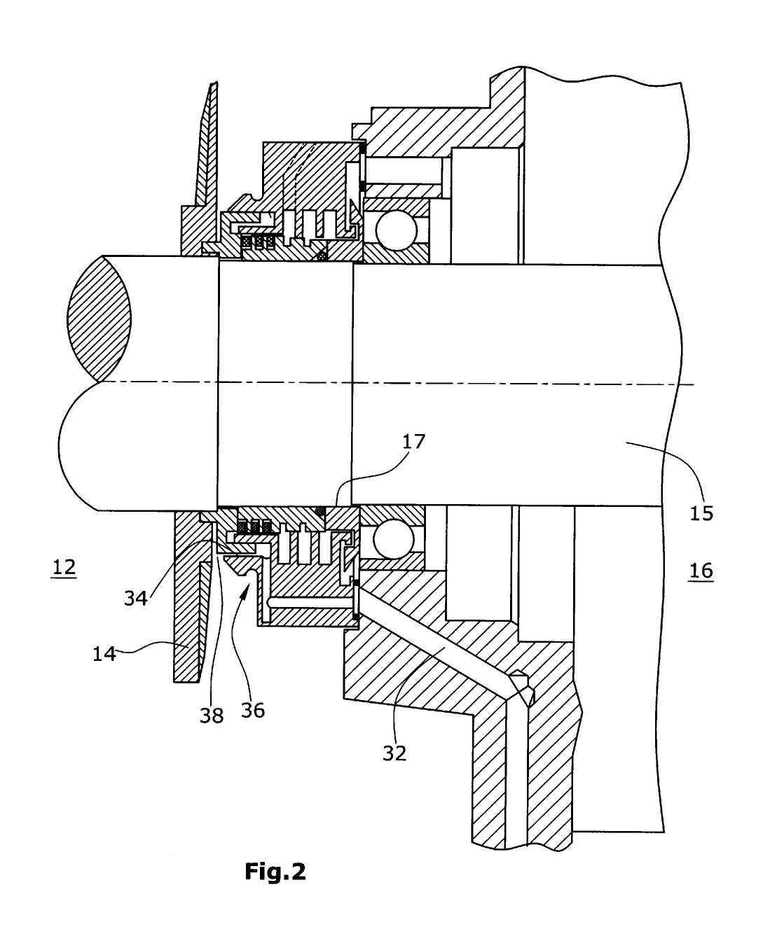

FIG. 2 is an enlarged detail of FIG. 1.

The vacuum pump 10 illustrated comprises a pump chamber 12 (suction chamber) in which a rotor 14 is supported for axial compression. The rotor 14 is driven via a transmission arranged outside the pump chamber 12 and contained in a transmission compartment 16. The pump chamber 12 is enclosed by a housing 18. The housing 18 has a pump chamber inlet 20 and a pump chamber outlet 22. The shaft 15 of the rotor 14 is passed from the pump chamber 12 into the transmission compartment 16 through a passage 17 between the housing 18 and the transmission compartment 16. The passage 17 is shown in detail in FIG. 2.

A degassing opening 24 is formed in the top of the housing, onto which a degassing pipeline 26 is set. The degassing pipeline 26 is connected with an exhaust gas line 30 which is connected with the pump chamber outlet 22.

When operating the vacuum pump with water vapor and diethyl zinc, these react as the pressure rises and form metal or oxidic deposits in the form of zinc or zinc oxide in the pump chamber. For the purpose of dissolving these impurities, first, the operation of the pump 10 is stopped and the pump chamber inlet 20, as well as the pump chamber outlet 22 is closed. Thereafter, the pump chamber 12 is flooded with a cleaning liquid 28 in the form of a cleaning solution containing citric acid. The subsequent movement of the rotor 14 distributes the cleaning liquid 28 uniformly and thus reaches all inner surfaces in the pump chamber 12 and especially also reaches parts of the pump and the rotors that are difficult to access. The cleaning liquid dissolves the deposits and forms a solution with the same. By repeatedly refilling fresh cleaning liquid 28 and moving the rotor 14 so as to distribute the cleaning liquid, still fresh cleaning liquid can reach remaining impurities and also dissolve these.

In order to prevent that accumulations of secondary gas keep the cleaning solution away from deposits, secondary gases are evacuated through the degassing opening 24. Since the degassing opening 24 is formed in the top portion of the housing 18, secondary gas can escape through the degassing opening 24 in the form of gas bubbles rising upward through the cleaning solution. A degassing pipeline 26 is set on the degassing opening 24, which pipeline vents the escaped secondary gas to atmosphere. In the embodiment illustrated in FIG. 1, the degassing pipeline 26 is guided into the exhaust gas line 30 of the pump chamber outlet 22.

Nitrogen is a typical secondary gas. For example, nitrogen is used as a gas ballast to avoid the condensation of water vapor during the operation of the pump. Nitrogen is further used as a sealing gas to seal the passage 17 of the rotor shaft from the transmission compartment 16 into the pump chamber 12, so that no impurities can get from the pump into the transmission compartment and the cleaning liquid cannot escape into the transmission compartment. In this context, the sealing gas is supplied to a gap 34 of the shaft seal 36 via a sealing gas supply line 32 and flows from the gap 34 into the pump chamber 12. Using the sealing gas nitrogen, a sealing accumulation of gas is formed in the region of the outlet side 38 of the passage 17, which can prevent the intrusion of the cleaning liquid 28 into the area to be sealed. In order to avoid sealing gas from accumulating beyond that and from shielding the surface to be cleaned, a vent is needed. This vent is realized by forming the degassing opening 24 above the outlet side 38 of the passage 17 since the sealing gas leaking from the gap 34 rises in the cleaning liquid 28 within the pump chamber 12 and accumulates in the region above the passage outlet side 38. The sealing gas is vented through the degassing opening 24.

After the impurities have been dissolved in the cleaning solution, the cleaning liquid 28 is drained from the pump chamber 12 together with the impurities dissolved. Thereafter, the pump chamber 12 is rinsed with clear water and then dried. Here, it is possible, in particular, to use a rinsing method known from prior art. After drying, the cleaning process is terminated and the vacuum pump 10 can be restarted.

1. A method for cleaning a vacuum pump including a pump chamber with at least one pump rotor the method comprising the following steps:
a) filling a cleaning liquid into the pump chamber,
b) distributing the cleaning liquid in the pump chamber,
c) dissolving impurities with the cleaning liquid,
d) draining the cleaning liquid from the pump chamber.

2. The method of claim 1, further including the steps of:
e) rinsing the pump chamber with a rinsing liquid,
f) drying the pump chamber.

3. The method of claim 2, wherein the cleaning liquid is an acidic cleaning solution and/or that the rinsing liquid is water.

4. The method of claim 1, wherein the cleaning liquid is distributed in the pump chamber by moving the rotor.

5. The method of claim 1, wherein prior to executing step a), pump operation is stopped and/or the pump chamber inlet and the pump chamber outlet are closed.

6. The method of claim 1, further including repeating the steps a) -c).

7. The method of claim 1, wherein the cleaning liquid contains citric acid and has an acidity of about 2% to 15%.

8. The method of claim 7, wherein the acidity is 10%.

9. The method of claim 1, further including stopping a supply of gas ballast, which prevents the condensation of the compressed gas, to the pump chamber.

10. The method of claim 1, further including reducing a sealing gas region between the pump chamber and an adjoining transmission compartment of the pump rotor.

11. The method of claim 1, wherein the vacuum pump includes a degassing opening in a top portion of the pump chamber and further including:
permitting gas accumulations, which prevent the cleaning liquid from reacting with impurities to be removed, to escape from the pump chamber through the degassing opening.

12. The method of claim 11, wherein the degassing opening is provided in a region above the outlet side of a rotor shaft passage from a transmission compartment to the pump chamber.

13. The method of claim 11, wherein a degassing pipeline is set on the degassing opening, such that the gas escaping being is guided through the pipeline to atmosphere.

14. The method of claim 11, wherein a degassing pipeline is set on the degassing opening, said degassing pipeline opening into an exhaust gas line connected to the pump chamber outlet.

15. The method of claim 11, wherein a degassing pipeline is set on the degassing opening, such that the gas escaping is guided through the pipeline to atmosphere.

16. The method of claim 11, wherein a degassing pipeline is set on the degassing opening, said degassing pipeline opening into an exhaust gas line connected to the pump chamber outlet.

17. A method of cleaning a vacuum pump, the method comprising:
stopping operation of the vacuum pump;
filling a pump chamber with an acidic cleaning liquid;
venting gases from a top portion of the pump chamber to atmosphere;
moving a rotor of the vacuum pump to distribute the cleaning liquid;
dissolving impurities coating the rotor and the pump chamber with the cleaning liquid; and
draining the cleaning liquid with the dissolved impurities from the pump chamber.
